(19) United States
(12) Patent Application Publication
(10) Pub. No.: US 2010/0099447 A1
(43) Pub. Date: Apr. 22, 2010

(54) Method and Apparatus for Use in a Communications Network

(76) Inventors: Christer Boberg, Tungelsta (SE); Anders Lindgren, Alvsjo (SE); Henrik Albertsson, Stockholm (SE)

Correspondence Address: ERICSSON INC., 6300 LEGACY DRIVE, M/S EVR 1-C-11, PLANO, TX, 75024, US

(21) Appl. No.: 12/518,597

(22) PCT Filed: Dec. 14, 2006
(86) PCT No.: PCT/EP06/69707

§ 371 Date: Oct. 28, 2009

(51) Int. Cl. H04W 4/12

(52) U.S. Cl. 455/466

(57) ABSTRACT

A system and method in a telecommunication network for subscribing a first node to receive event update notifications from a second node. The first node sends a subscription message such as a SIP SUBSCRIBE message to the second node indicating that the first node wishes to subscribe to event update notifications relating to at least one type of event for a plurality of remote nodes of the network that have a predetermined association with the first node or alternatively the second node. In response, the second node generates future event update notifications and sends the notifications to the first node when the event notifications meet the criteria specified in the subscription message.

### BACKGROUND OF THE INVENTION

1. Field of the Invention

The present invention relates to a method and apparatus for use in a communications network, for example a Universal Mobile Telecommunications System having an IP Multimedia Subsystem.

2. Description of the Related Art

IP Multimedia services provide a dynamic combination of voice, video, messaging, data, etc. within the same session. By growing the number of basic applications and the media which it is possible to combine, the number of services offered to the end users will grow, and the inter-personal communication experience will be enriched. This will lead to a new generation of personalised, rich multimedia communication services, including so-called “combinational IP Multimedia” services.

The UMTS (Universal Mobile Telecommunications System) is a third generation wireless system designed to provide higher data rates and enhanced services to subscribers. UMTS is a successor to the Global System for Mobile Communications (GSM), with an important evolutionary step between GSM and UMTS being the General Packet Radio Service (GPRS). GPRS introduces packet switching into the GSM core network and allows direct access to packet data networks (PDNs). This enables high-data rate packets switch transmissions well beyond the 64 kbps limit of ISDN through the GSM call network, which is a necessity for UMTS data transmission rates of up to 2 Mbps. UMTS is standardised by the 3^{rd} Generation Partnership Project (3GPP) which is a conglomeration of regional standards bodies such as the European Telecommunication Standards Institute (ETSI), the Association of Radio Industry Businesses (ARIB) and others. See 3GPP TS 23.002 for more details.

The UMTS architecture includes a subsystem known as the IP Multimedia Subsystem (IMS) for supporting traditional telephony as well as new IP multimedia services (3GPP TS 22.228, TS 23.228, TS 24.229, TS 29.228, TS 29.229, TS 29.328 and TS 29.329 Releases 5 to 7). IMS provides key features to enrich the end-user person-to-person communication experience through the use of standardised IMS Service Enablers, which facilitate new rich person-to-person (client-to-client) communication services as well as person-to-content (client-to-server) services over IP-based networks. The IMS is able to connect to both PSTN/ISDN (Public Switched Telephone Network/Integrated Services Digital Network) as well as the Internet.

The IMS makes use of the Session Initiation Protocol (SIP) to set up and control calls or sessions between user terminals (or user terminals and application servers). The Session Description Protocol (SDP), carried by SIP signalling, is used to describe and negotiate the media components of the session. Whilst SIP was created as a user-to-user protocol, IMS allows operators and service providers to control user access to services and to charge users accordingly. The 3GPP has chosen SIP for signalling between a User Equipment (UE) and the IMS as well as between the components within the IMS.

Specific details of the operation of the UMTS communications network and of the various components within such a network can be found from the Technical Specifications for UMTS that are available from http://www.3gpp.org. Further details of the use of SIP within UMTS can be found from the 3GPP Technical Specification TS 24.228 V5.8.0 (2004-03).

FIG. 1 of the accompanying drawings illustrates schematically how the IMS fits into the mobile network architecture in the case of a GPRS/PS access network (IMS can of course operate over other access networks). Call/Session Control Functions (CSCFs) operate as SIP proxies within the IMS. The 3GPP architecture defines three types of CSCFs: the Proxy CSCF (P-CSCF) which is the first point of contact within the IMS for a SIP terminal; the Serving CSCF (S-CSCF) which provides services to the user that the user is subscribed to; and the Interrogating CSCF (I-CSCF) whose role is to identify the correct S-CSCF and to forward to that S-CSCF a request received from a SIP terminal via a P-CSCF.

A user registers with the IMS using the specified SIP REGISTER method. This is a mechanism for attaching to the IMS and announcing to the IMS the address at which a SIP user identity can be reached. In 3GPP, when a SIP terminal performs a registration, the IMS authenticates the user, and allocates a S-CSCF to that user from the set of available S-CSCFs. Whilst the criteria for allocating S-CSCFs is not specified by 3GPP, these may include load sharing and service requirements. It is noted that the allocation of an S-CSCF is key to controlling (and charging for) user access to IMS-based services. Operators may provide a mechanism for preventing direct user-to-user SIP sessions which would otherwise bypass the S-CSCF.

During the registration process, it is the responsibility of the I-CSCF to select an S-CSCF if a S-CSCF is not already selected. The I-CSCF receives the required S-CSCF capabilities from the home network's Home Subscriber Server (HSS), and selects an appropriate S-CSCF based on the received capabilities. [It is noted that S-CSCF allocation is also carried out for a user by the I-CSCF in the case where the user is called by another party, and the user is not currently allocated an S-CSCF.] When a registered user subsequently sends a session request to the IMS, the P-CSCF is able to forward the request to the selected S-CSCF based on information received from the S-CSCF during the registration process.

Within the IMS service network, Application Servers (ASs) are provided for implementing IMS service functionality. Application Servers provide services to end-users in an IMS system, and may be connected either as end-points over the 3GPP defined Mr interface, or “linked in” by an S-CSCF over the 3GPP defined ISC interface. In the latter case, Initial Filter Criteria (IFC) are used by an S-CSCF to determine which Applications Servers should be “linked in” during a SIP Session establishment. Different IFCs may be applied to different call cases. The IFCs are received by the S-CSCF from an HSS during the IMS registration procedure as part of a user's User Profile. Certain Application Servers will perform actions dependent upon subscriber identities (either the called or calling subscriber, whichever is “owned” by the network controlling the Application Server). For example, in the case of call forwarding, the appropriate (terminating) application server will determine the new terminating party to which a call to a given subscriber will be forwarded. In the case that an IFC indicates that a SIP message received at the S-CSCF should be forwarded to a particular SIP AS, that AS is added into the message path. Once the SIP message is returned by the AS to the S-CSCF, it is forwarded on towards its final destination, or forwarded to another AS if this is indicated in the IFCs.

An example of a SIP AS is a notification server (NS). A notification server might be used, for example, to provide a presence service to IMS subscribers. A presence service allows subscribers to publish details of their current availability, location and contact addresses to other subscribers. A subscriber subscribes to a presence service by sending a SIP SUBSCRIBE method to its S-CSCF, with the S-CSCF forwarding the SUBSCRIBE method to the notification server based on the IFC settings. The notification server may direct new Subscribe Requests to other notification servers, e.g. when a notification server acts as a subscribing proxy on behalf of a subscribing user. A subscriber publishes a change to his or her current presence information by sending a SIP PUBLISH method to the notification server via the S-CSCF. A notification server may apply a rate limitation to the sending of notifications, e.g. to allow all notification generated within a given time window to be sent as a single block of data.

To learn about the registration status of a user, an interested party, for example an Application Server (AS), would subscribe to the register information from the registrar (e.g. the S-CSCF in the IMS, or a dedicated notification server) by using the SIP SUBSCRIBE/NOTIFY method, and would include information in the SIP SUBSCRIBE message about the desired information (a specific event package “regevent”) and the URI of the user in question. A SIP NOTIFY message would be sent to the subscriber if and when the user in question performs the SIP REGISTER procedure. The SIP SUBSCRIBE/NOTIFY method is described in detail in RFC 3265.

It is also possible for the registrar to use other mechanisms, such as a Third Party Register, but to get all the required information, such as implicit registered users, proprietary extensions are required since they are currently not standardised. At present, subscription to a register event is the preferred solution in the 3GPP standardization forum, and not a Third Party Register mechanism.

### SUMMARY OF THE INVENTION

The main problem with the subscription to register event solution is that it is necessary to use one separate subscription per user in question and there might be several millions users existing in the network and also many Application Servers that are interested in this information. As both a registrar node and an Application Server node are capable of handling a huge number of users, this means that a node may be handling a huge number of subscriptions coming from a particular Application Server node. This also means that the number of subscriptions between two nodes may be very large, and SIP subscriptions require a lot of resources, such as memory. The number of messages exchanged may also be very large, not only for the notifications due to changes in the registration status, but also due to all initial, refresh and final subscription messages that will be sent.

According to a first aspect of the present invention there is provided a method for use by a first node in a subscribe/notify procedure of a telecommunications network, the method comprising sending a subscription message indicating that the first node wishes to subscribe to event update notifications relating to at least one type of event for a plurality of remote nodes of the network, such that, in response to receipt of the subscription message at a second node of the network, the second node is caused to send future event update notifications to the first node if they relate to the at least one type of event.

According to a second aspect of the present invention there is provided a method for use by a second node in a subscribe/notify procedure of a telecommunications network, the method comprising receiving a subscription message sent from a first node of the network, the subscription message indicating that the first node wishes to subscribe to event update notifications relating to at least one type of event for a plurality of remote nodes of the network, and, in response to receipt of the subscription message, causing future event update notifications to be sent to the first node if they relate to the at least one type of event.

The subscription message may indicate that the first node wishes to subscribe to event update notifications for remote nodes of the network that have a predetermined association with the first node.

A predetermined association may exist between the remote node and the first node if the remote node is known to the first node.

A predetermined association may exist between the remote node and the first node if the first node has been requested to provide a service to the remote node.

The method may comprise determining whether a remote node has the predetermined association with the first node with reference to a remote persistent storage.

The remote persistent storage may comprise a remote subscriber database.

Receipt of the subscription message may cause future event update notifications to be sent to the first node only for those remote nodes having the predetermined association with the first node.

The subscription message may indicate that the first node wishes to subscribe to event update notifications for remote nodes of the network that have a predetermined association with the second node.

A predetermined association may exist between the remote node and the second node if the remote node is known to the second node.

A predetermined association may exist between the remote node and the second node if the second node has been requested to provide a service to the remote node, such as a presence service.

Receipt of the subscription message may cause future event update notifications to be sent to the first node only for those remote nodes having the predetermined association with the second node.

Receipt of the subscription message may cause future event update notifications to be sent to the first node only for remote nodes satisfying a predetermined criterion or criteria, the predetermined criterion or criteria being specified in the subscription message.

The subscription message may not identify each of the remote nodes.

The subscription message may not identify any of the remote nodes.

The subscription message may identify the at least one type of event to be subscribed to.

The subscription message may indicate either implicitly or explicitly that all types of event are to be subscribed to.

The at least one type of event may comprise a register type event.

The at least one type of event may comprise only a register type event.

The second node may be a registrar node.

The subscribe/notify procedure may be the Session Initiation Protocol, SIP, subscribe/notify procedure, the subscription message is a SIP SUBSCRIBE message and the event update notifications are SIP NOTIFY messages.

The indication may be provided at least partly by the Request-URI field of the SUBSCRIBE message specifying the Uniform Resource Identifier, URI, of the second node.

At least one type of event update may be made known to the second node through the sending of a SIP PUBLISH message by a remote node.

At least one type of event update may be made known to the second node through the sending of a SIP REGISTER message by a remote node.

The telecommunications network may be a Universal Mobile Telecommunications System having an IP Multimedia Subsystem.

The second node may be a Serving Call/Session Control Function.

The first node may be an Application Server.

The remote subscriber database may be a Home Subscriber Server.

The subscription message received at the second node may be the same as or derived from the subscription message sent from the first node.

The second node may be scaled over a plurality of instances.

According to a third aspect of the present invention there is provided an apparatus for use by a first node of a telecommunications network for performing a method in a subscribe/notify procedure, comprising means for sending a subscription message indicating that the first node wishes to subscribe to event update notifications relating to at least one type of event for a plurality of remote nodes of the network, such that, in response to receipt of the subscription message at a second node of the network, the second node is caused to send future event update notifications to the first node if they relate to the at least one type of event.

According to a fourth aspect of the present invention there is provided an apparatus for use by a second node of a telecommunications network for performing a method in a subscribe/notify procedure, comprising means for receiving a subscription message sent from a first node of the network, the subscription message indicating that the first node wishes to subscribe to event update notifications relating to at least one type of event for a plurality of remote nodes of the network, and, in response to receipt of the subscription message, causing future event update notifications to be sent to the first node if they relate to the at least one type of event.

According to a fifth aspect of the present invention there is provided a program for controlling an apparatus to perform a method according to the first or second aspect of the present invention or which, when loaded into an apparatus, causes the apparatus to become an apparatus according to the third or fourth aspect of the present invention. The program may be carried on a carrier medium. The carrier medium may be a storage medium. The carrier medium may be a transmission medium.

According to a sixth aspect of the present invention there is provided an apparatus programmed by a program according to the fifth aspect of the present invention.

According to a seventh aspect of the present invention there is provided a storage medium containing a program according to the fifth aspect of the present invention.

An embodiment of the present invention makes it possible to use only one SIP Subscription from each AS instance to each registrar instance, for example by addressing the subscription to register event information to the registrar itself and not by addressing the user.

### BRIEF DESCRIPTION OF THE DRAWINGS

FIG. 1, discussed hereinbefore, illustrates schematically the integration of an IP Multimedia Subsystem into a 3G mobile communications system; and

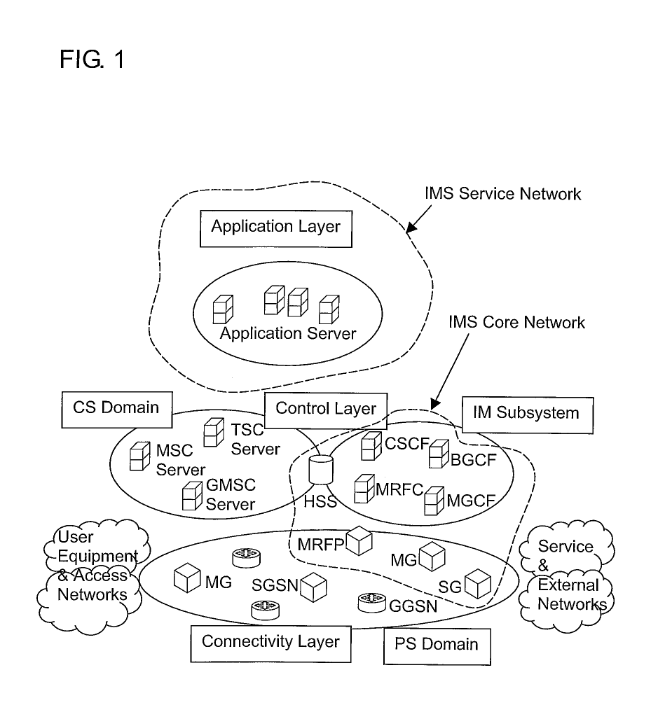

FIG. 2 is a signalling diagram illustrating a subscribe/notify procedure according to an embodiment of the present invention.

### DETAILED DESCRIPTION OF THE PREFERRED EMBODIMENTS

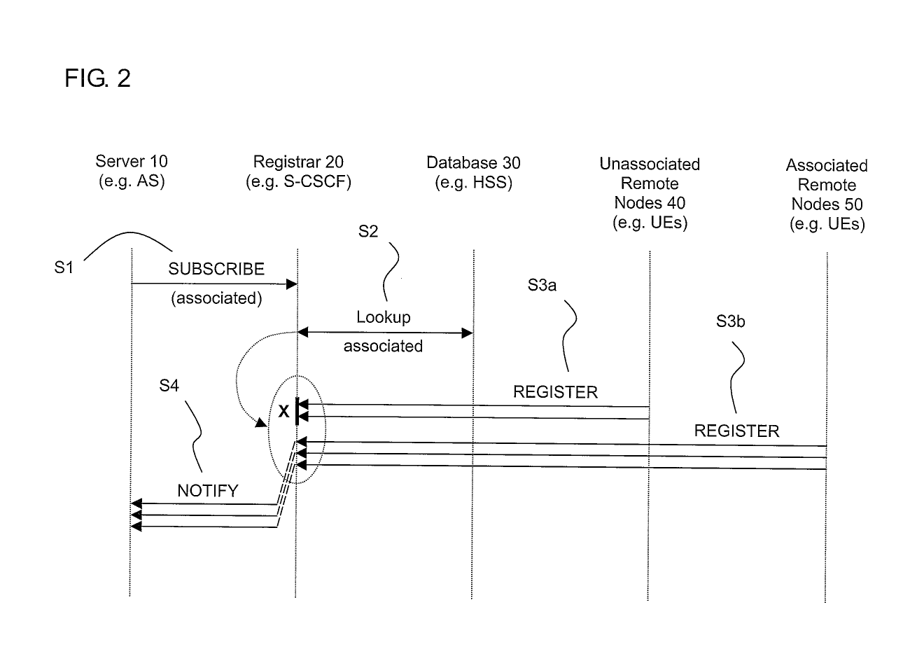

An embodiment of the present invention will now be described with reference to the signalling diagram of FIG. 2. This embodiment involves a server node 10, a registrar node 20, a database node 30, remote nodes 40 not having an association with the server node 10, and remote nodes 50 having an association with the server node 10.

This embodiment will be described in the context of a Universal Mobile Telecommunications System having an IP Multimedia Subsystem, such that the server node 10 will be considered as being an Application Server, the registrar node 20 will be considered as being an S-CSCF, the database node 30 will be considered as being an HSS, and the remote nodes 40, 50 will be considered as being User Equipments (UEs).

An embodiment of the present invention provides part of a subscribe/notify procedure, which in the context of the IMS would be the SIP SUBSCRIBE/NOTIFY procedure described briefly above.

This embodiment will be described with reference to two separate parts. The first part describes how the server node 10 creates the subscription, and the second part describes how the registrar node 20 finds out for what users the register event information shall be sent to that particular server node 20.

### 1. Creation of the Subscription

The actual creation of the subscription request in an embodiment of the present invention generally follows the standard procedure as set out in RFC 3265, and the reader is referred to RFC 3265 for details. In RFC 3265, the Request URI of a SUBSCRIBE request contains enough information to route the request to the appropriate entity, and also contains enough information to identify the resource for which event notification is desired.

However, an embodiment of the present invention differs from the procedure set out in RFC 3265 in that the SUBSCRIBE message (step S1) comprises an indication that the server node wishes to subscribe more generally to event update notifications from remote nodes of the network that have a predetermined association with the server node. This predetermined association will be described in more detail below. In this embodiment, the indication is that the Request-URI field of the SUBSCRIBE message specifies the Uniform Resource Identifier, URI, of the registrar node 20, rather than a particular one of the remote nodes 40, 50.

One potential problem associated with this approach is that the registrar node 20 is normally scaled over several instances, and it is not possible to fork the subscription request. This means that the Watcher, the server node 10, must be provided with the capability of knowing or learning the registrar node instances that exist in the network.

This can be achieved either by configuring the list of registrar nodes in the server node 10, or by causing the server node 10 to read the list of registrar nodes from a directory or from the DNS. The actual mechanism for achieving this will be implementation specific, and is not relevant to the core idea underlying an embodiment of the present invention.

Each subscription request is routed as normal by the IMS network and ends up in the registrar node 20 pointed identified in the Request-URI. Any refresh/terminate subscription requests are handled as normal.

### 2. Sending Notification to the Watcher

One possibility for sending notifications to the Watcher (the server node 10) would be for the registrar node 20 to send information about all its known users to the server node 10. However, whilst this is within the possibilities for an embodiment of the present invention, this would mean that the server node 10 would receive information about users that are not known by the server node 10, and even users that do not have any service related to the server node 10.

To avoid this, the registrar node 20 in this particular embodiment is adapted to check which server node 10 sent the Request (known e.g. from the address in the contact header field) and to compare this information with the SIP-AS address known from the trigger information obtained (step S2) from the HSS 30. The registrar node 20 can then ensure that only information about users that have triggers pointing to that particular server node 10 instance is sent to that server node 10 instance, and unnecessary notifications are thereby avoided.

In this way, for each event update that is posted from a remote node 40, 50 with a SIP REGISTER message (steps S3a and S3b), it is checked whether there is a predetermined association between the remote node concerned and the server node 10. If there is determined to be such an association, then a related SIP NOTIFY message is sent to the server node 10 (step S4). If not, then a SIP NOTIFY message is not sent to the server node 10.

An association may found if the remote node is known in some way to the server node 10, or there may be required to be a more specific association in which the server node 10 has been requested to provide a service to the remote node. Other possibilities would be readily apparent to the skilled person.

The main advantage with a method embodying the present invention compared to presently-proposed solutions is that the same behaviour and information is obtained with an embodiment of the present invention with far fewer resources. This has an effect in decreasing the cost/performance for the product.

A method embodying the present invention as described above follows standard IMS solutions to a large extent, but changes are required in the registrar node (S-CSCF) 20 and the server node (AS) 10 to provide the modified functionality.

It is possible to include a flag in the subscribe request to indicate that the subscribe request relates to a multi-subscribe, for example a subscribe for all resources related to the S-CSCF.

It will be appreciated that operation of one or more of the above-described components can be controlled by a program operating on the device or apparatus. Such an operating program can be stored on a computer-readable medium, or could, for example, be embodied in a signal such as a downloadable data signal provided from an Internet website. The appended claims are to be interpreted as covering an operating program by itself, or as a record on a carrier, or as a signal, or in any other form.

It will also be appreciated by the person of skill in the art that various modifications may be made to the above described embodiments without departing from the scope of the present invention as defined by the appended claims. In particular, it will be appreciated that, although described in relation to a Universal Mobile Telecommunications System having an IP Multimedia Subsystem and using the SIP SUBSCRIBE/NOTIFY procedure, the present invention is also applicable to other types of network, and also in a situation in which a different type of subscribe/notify type procedure is used. It is noted in particular that embodiment of the present invention are not limited to the use of register event and registrars as described above in the main embodiment, but can be used for any similar procedure where the same problem would exist.

It is also not essential to an embodiment of the present invention that the AS (or other type of node) subscribes only to events relating to users associated in some way with that AS. For example, an embodiment of the present invention would make it possible to provide for a cluster of ASs subscribing to presence from a Presence Server for all users that are related to that particular Presence Server instance, rather than all users that are related to a particular AS instance. In this case, it is not possible for the Presence Server to determine which users are connected to the specific ASs, since the PS does not have access to the triggers.

The AS might anyway be desirous of obtaining event update notifications even for remote nodes that have no association with it or even any other node of the network, i.e. regardless of the remote node concerned.

A node may also wish to subscribe to events other than the register event that is the main focus of the embodiment described in detail above. For other types of event, updates to the event can be posted by use of the SIP PUBLISH message, rather than the SIP REGISTER procedure that might trigger a register event update notifications.

A node may wish to subscribe to a particular event for any remote node, or for any events for any remote nodes, or for particular events for any remote node associated with the notification server that is handling the sending of notification messages, or associated with another node entirely; other possibilities like these would be readily apparent to the skilled person. The use of the term “registrar node” is applicable in the case of subscribing to register events, but may not be applicable in other embodiments of the present invention. Embodiments of the present invention are also not limited to event update notifications, but may also be applied in respect of other types of update notification.

What is claimed is:

1-39. (canceled)

40. A method of subscribing to event update notifications in a telecommunication network, the method comprising the steps of:
sending from a first node, a subscription message indicating that the first node wishes to subscribe to event update notifications relating to at least one type of event for a plurality of remote nodes of the network that have a predetermined association with the first node;
receiving the subscription message at a second node; and
in response to receiving the subscription message at the second node, generating future event update notifications and sending the notifications from the second node to the first node when the event notifications relate to the at least one type of event and relate to one of the plurality of remote nodes that has the predetermined association with the first node.

41. The method as claimed in claim 40, wherein a predetermined association exists between the remote node and the first node if the remote node is known to the first node.

42. The method as claimed in claim 40, wherein a predetermined association exists between the remote node and the first node if the first node has been requested to provide a service to the remote node.

43. The method as claimed in claim 40, further comprising determining whether a remote node has the predetermined association with the first node with reference to a remote persistent storage comprising a subscriber database.

44. A method of subscribing to event update notifications in a telecommunication network, the method comprising the steps of:
sending from a first node to a second node, a subscription message indicating that the first node wishes to subscribe to event update notifications relating to at least one type of event for a plurality of remote nodes of the network that have a predetermined association with the second node;
receiving the subscription message at the second node; and
in response to receiving the subscription message at the second node, generating future event update notifications and sending the notifications from the second node to the first node when the event notifications relate to the at least one type of event and relate to one of the plurality of remote nodes that has the predetermined association with the second node.

45. The method as claimed in claim 44, wherein a predetermined association exists between the remote node and the second node if the remote node is known to the second node.

46. The method as claimed in claim 44, wherein a predetermined association exists between the remote node and the second node if the second node has been requested to provide a presence service to the remote node.

47. The method as claimed in claim 44, wherein the subscription message indicates either implicitly or explicitly that all types of events are to be subscribed to.

48. The method as claimed in claim 44, wherein the at least one type of event comprises a register type event.

49. The method as claimed in claim 44, wherein the second node is a registrar node.

50. The method as claimed in claim 44, wherein the subscription message is a Session Initiation Protocol (SIP) SUBSCRIBE message, and the event update notifications are SIP NOTIFY messages.

51. The method as claimed in claim 50, wherein the subscription message indicates that the first node wishes to subscribe to event update notifications utilizing a Request-URI field of the SUBSCRIBE message specifying a Uniform Resource Identifier (URI) of the second node.

52. The method as claimed in claim 50, further comprising receiving by the second node, an event update from a remote node sent in a SIP PUBLISH message by the remote node.

53. The method as claimed in claim 50, further comprising receiving by the second node, an event update from a remote node sent in a SIP REGISTER message by the remote node.

54. The method as claimed in claim 44, wherein the second node is a Serving Call/Session Control Function (S-CSCF) in a Universal Mobile Telecommunications System having an IP Multimedia Subsystem.

55. The method as claimed in claim 44, wherein the first node is an Application Server.

56. The method as claimed in claim 44, wherein the second node is scaled over a plurality of instances.

57. A system in a telecommunication network for subscribing a first node to receive event update notifications from a second node, the system comprising:
communication means in the first node for sending a subscription message to the second node indicating that the first node wishes to subscribe to event update notifications relating to at least one type of event for a plurality of remote nodes of the network that have a predetermined association with the first node;
communication means in the second node for receiving the subscription message; and
means responsive to receiving the subscription message in the second node, for generating future event update notifications and for sending the notifications to the first node when the event notifications relate to the at least one type of event and relate to one of the plurality of remote nodes that has the predetermined association with the first node.

58. A system in a telecommunication network for subscribing a first node to receive event update notifications from a second node, the system comprising:
communication means in the first node for sending a subscription message to the second node indicating that the first node wishes to subscribe to event update notifications relating to at least one type of event for a plurality of remote nodes of the network that have a predetermined association with the second node;
communication means in the second node for receiving the subscription message; and
means responsive to receiving the subscription message in the second node, for generating future event update notifications and for sending the notifications to the first node when the event notifications relate to the at least one type of event and relate to one of the plurality of remote nodes that has the predetermined association with the second node.
